(19) United States
(12) Patent Application Publication
(10) Pub. No.: US 2006/0039518 A1
(43) Pub. Date: Feb. 23, 2006

(54) Thermal cavitation focusing, inertial containment test equipment

(76) Inventor: Jason L. Hornkohl, Nashville, TN (US)

Correspondence Address: Jason L. Hornkohl, Suite 2020, 414 Union Street, Nashville, TN, 37219, US

(21) Appl. No.: 10/979,377

(22) Filed: Nov. 2, 2004

Related U.S. Application Data
(63) Continuation-in-part of application No. 10/147,739, filed on May 16, 2002, now abandoned.

(51) Int. Cl. H05H 1/22; G21B 1/00

(52) U.S. Cl. 376/100

(57) ABSTRACT

A method and apparatus for controlling cavitation to form a high pressure zone and/or jets of material is provided by the present invention. A unstable, superheated phase bubble is created by applying a voltage pulse to a firing resistor in a reaction chamber and imploded to produce a high pressure region. The reaction chamber has sloped edges that focus opposing shock waves created by the imploding phase bubble toward a high pressure reacting region. The liquid is filled with deuterium, tritium, uranium, unstable isotopes, and/or other materials that are susceptible to nuclear or chemical reactions at high pressures. The resulting reactions can be used for countless applications.

The following application is a continuation-in-part of, and claims priority based upon, co-pending application Ser. No. 10/147,739, Filed: May 16, 2002

### FIELD OF THE INVENTION

The present invention relates generally to a bubble imploder for creating high pressure regions that are useful for a variety of applications. More particularly, the present invention relates to the use of heating resistor type bubble imploder having a construction that creates a bubble and focuses the bubble's implosion and/or explosion to create an extremely high pressure region and/or directed jets of material.

### BACKGROUND OF THE INVENTION

There are a variety of reasons that mankind has been trying to create high pressure regions and jets of material. For example, high pressure jets of water have been used as cleaning and cutting tools for some time. The obvious advantage of such a cutting tool is that there is no blade to wear out. However, the equipment needed to create and contain the pressures required to make such tools effective tends to be bulky and expensive. As another example, some chemical reactions only occur at higher pressures. Therefore, pressure vessels have been constructed to contain the pressures required for the particular reactions. Unfortunately, these vessels are also bulky and expensive. Therefore, what is needed is a less expensive, more compact way of creating high pressure regions and jets of material.

People have been searching for the secret of fusion power for over 50 years. Efforts to create fusion power have been so unsuccessful to date that many in the scientific community immediately dismiss any reports of progress. However, the utility of such a source of power is self-evident. Perhaps surprisingly to some, there are many known ways of creating fusion. Both fusion bombs and reactors have been public knowledge for decades and the sun shines every day. It is well known that very high pressures and temperatures are necessary to create a fusion reaction. Unfortunately, the type of reactions created in the past were typically reactions that produced such extremely large amounts of energy that they were impossible to contain or such extremely small amounts of energy that they were economically impossible to use. For instance, in sonoluminescence experiments, the energy produced is so low that the very existence of fusion is in doubt among scholars and, thus, the devices are so far only useful for experimentation. These prior art sonoluminescent devices use sound waves to indirectly create bubble cavitation and corresponding flashes of light. Unfortunately, none of the known methods for creating fusion are economically useful for power. Therefore, what is needed is an improved method for creating extremely high pressure regions.

### SUMMARY OF THE INVENTION

A preferred embodiment of the present invention is directed toward a bubble implosion focusing device that includes a heating element for producing a superheated, cavitating bubble in a liquid and a reaction chamber for focusing the explosion and/or implosion of the bubble into a high pressure zone or directed jet of material. A preferred reaction chamber is shaped like a pair of hollow opposed cones constructed through a semiconductor deposition and etching process wherein the points of the hollow cones are joined and wherein the resistive heating element is positioned adjacent the junction of the hollow cones such that sidewalls of the hollow opposed cones shape the expansion and implosion of the phase bubble. In such an embodiment, the walls of the reaction chamber are preferably sloped to focus the implosion toward a central point positioned away from the heating resistor to avoid damage to the resistor. A microprocessor controlled pulse generator is used to provide precisely controlled voltage pulses to the firing resistors. The voltage level, current level and pulse shape of the electric pulses sent to the firing resistor selectively control the amount and speed at which energy is applied to the liquid in the reaction chamber by the heating resistor. The liquid is preferably water but may be any liquid in which a phase bubble can be created such as alcohol and acetone. Furthermore, practically any substance desired can be incorporated or dissolved into the liquid. For example, salt may be dissolved in water or the hydrogen in water replaced with radioactive isotopes such as deuterium and tritium. The thermal conductivity of the material from which the heating elements and reaction chamber are constructed is selected to be as high as possible such that a rapid bubble explosion/implosion, and thus cavitation, is created. A diamond-like-carbon or talcum coated surface is preferred in high precision semiconductor applications to prevent damage to the heating surface and provide high rates of thermal transfer. However, a ceramic or metal firing resistor and reaction chamber may be used in applications such as cutting tools where the precision required may be less critical. In such an alternative cutting embodiment, the reaction chamber would be sloped to create a cavitation based implosion that is focused on a particular point on a surface to thereby cut the surface. The surface of the resistive heating element may be contoured to shape, focus or direct the bubble implosion. The liquid maybe also be pressurized or cooled to increase the implosive force of the cavitation.

### BRIEF DESCRIPTION OF THE DRAWINGS

FIG. 1 is a diagram of a preferred embodiment of the present invention having sloped edges for directing a bubble implosion;

FIG. 2 shows the preferred embodiment of FIG. 2 with a bubble expanded to its full extent.

FIG. 3 is a diagram illustrating the principles of bubble implosion utilized by the embodiments of the present invention;

FIG. 4 is a diagram of an embodiment of the present invention that utilizes contoured heating surfaces to influence the bubble implosion;

FIG. 5 is a diagram of an embodiment of the present invention having a single heating element;

FIG. 6 is an embodiment of the present invention using a firing resistor; and

FIG. 7 is a flow chart of a method for focusing a bubble implosion in accordance with a preferred embodiment of the present invention.

### DETAILED DESCRIPTION

Shaped charges are used to influence the direction and nature of an explosion. By shaping the explosive into a hollowed-out cone, a high-pressure concentrated shock wave is created that is centered in the cone and directed away from the apex of the cone. This directed shock wave can be used to tunnel through the armor of a tank or create a high pressure region in which nuclear material undergoes fusion or fission. More particularly, opposing, high pressure gas shock waves can be directed to collide and create a relatively small area of extremely high pressure. The explosives can be shaped to form practically any shape of shock wave desired. For example, bent angle explosive charges, in the form of a triangle missing the base leg, create a longitudinal shock wave that may be used to cut through steel beams when demolishing buildings or blasting open doors. In an explosion of a hollow sphere, a shock wave is created that implodes on the center and creates a high pressure zone. Unfortunately, a violent outward explosion also accompanies the inward implosion that is so forceful and strong that it is often hard to contain. Thus, one problem with practical fusion is that it is hard to contain. Any usable fusion reaction must be either contained or very small. The present invention has applicability to fusion power research and experimentation in that provides the ability to create a very small high pressure region using inertial confinement in an economical, reliable and controllable manner.

Heating resistor based ink jet printers are extremely complex modern products that eject small drops of ink to create an image. Basically, a heating resistor type of ink jet printer functions by vaporizing a small drop of ink to create a bubble that ejects a drop of ink. It is the extremely small size and high speed of operation that make these devices amazing. They can produce very high resolution images consisting of millions of tiny ink spots at very high speeds. The bubble of exploding ink used to eject the drop of ink has a very short life that is accompanied by an extremely violent explosion and implosion of water molecules in the form of a cavitating phase bubble.

Fusion reactions caused by cavitating bubbles are believed by many in the scientific community to produce sonoluminescence. However, the number of particles that have enough kinetic energy to overcome their nuclear forces during an implosion caused collision is extremely small. The present invention is directed toward recognizing the factors that are controlling this cavitation reaction and improving the ability to focus the cavitation reactions to the point that they are capable of producing extraordinarily high pressures.

The following references were considered when drafting the description of the invention herein and are hereby incorporated into the disclosure of this patent by reference. Copies are contained in the prosecution history of the application that resulted in the grant of this patent.

U.S. Pat. Nos. 6,350,016; 6,331,043; 6,267,468; 6,206,508; 6,131,518; 6,126,260, 6,126,269; 6,109,735; 6,035,897; 5,969,207; 5,795,460; 5,734,398; 5,086,974; 4,149,266

Effects of ionization in single-bubble sonoluminescence, Physical Review E, Volume 65, 041201, Mar. 15, 2002.

Fusion-in-a bubble sparks controversy, Physics Web, Mar. 5, 2002.

Sound waves size up sonoluminescence, Physics Web, Feb. 5, 2002.

Boosting Sonoluminescence with a High-Intensity Ultrasonic Pulse Focused on the Bubble by an Adaptive Array, Physical Review Letters, Volume 88, Number 7, Feb. 18, 2002.

Effect of Volatile Solutes on Sonoluminescence, Journal of Chemical Physics, Volume 116, Number 7, Feb. 15, 2002.

Temperature in Multibubble Sonoluminescence, Journal of Chemical Physics, Volume 115, Number 7, Aug. 15, 2001.

Sonoluminescence and the Prospects for table-Top Micro-Thermonuclear Fusion, Lawrence Livermore National Laboratory.

Tabletop Fusion Report Elicits Mixed Reaction, Washington Post, Mar. 5, 2002, Page A01.

Among other things, the present invention takes advantage of two concepts that are in completely unrelated fields. First, a rapidly collapsing bubble in a super heated liquid produces relatively small areas of extremely high pressures. For example, a bubble produced in an ink jet printer results when a burst of energy in the form of an electrical pulse is sent to a resistor that superheats and vaporizes a small portion of the ink thereby forming a vaporized bubble that ejects a drop of ink from the nozzle. When the electrical pulse is over, the vapor in the bubble rapidly returns to the liquid state and collapses onto itself and the surface of the firing resistor. The force of this bubble collapsing is strong enough to pit the surface of a layer of protective material that is used for the very purpose of preventing this damage. The shock wave created is by design a relatively flat, unfocussed shock wave that collapses onto the surface of the resistor with as little force as possible. The effects of this collapse are sometimes referred to as cavitation damage or pitting. The cavitation or bubble collapses of the preferred embodiments of the present invention are more properly referred to as thermally induced, inertially confining, focused bubble cavitation. This bubble cavitation creates pressures that pit diamond surfaced materials even when the bubble implosion shock wave is not focused. Second, sonoluminescence experiments have shown, that the temperatures, densities and pressures created by the acoustically created cavitating bubbles used in the experiments are strong enough to initiate a fusion reaction that releases neutrons and tritium. The low, almost unobservable energy output of sonoluminescence is due to the fact that the prior art is utilizing unfocused bubble cavitation created indirectly using acoustic sound waves, not thermal pulses.

A preferred embodiment of the present invention produces and implodes a focused bubble of superheated liquid in an extremely short amount of time. The bubble is contained within a partially enclosed chamber that creates a high pressure collapse zone. The preferred embodiments improve upon the prior art by rapidly and completely focusing the collapsing bubble in a collapse zone in a manner that creates higher pressures. The embodiments utilize the concept of a shaped charge to focus the bubbles' implosion into the collapse zone. Cavitation based shock waves created in a bubble implosion in a superheated liquid are shaped like the shockwaves created by explosives to provide an extremely small high-pressure zone for initiating reactions or creating molecules in high pressure environments. While explosives blow outward to create an inner high pressure region, the bubbles of the present invention preferably implode upon themselves after expanding as the material in the bubble changes from the gas to the liquid state. This complete implosion produces a larger shockwave and correspondingly higher pressure core than the acoustically cavitating bubbles utilized in prior single bubble and multi-bubble sonoluminescence experiments. In the prior art cavitating bubbles of the sonoluminescence experiments, “Idealized theoretical extrapolations indicate that as the shock radius passes through 60 A the temperatures and densities are high enough for fusion”. Thus, the prior art, arguably, shows that cavitation produces pressures in localized areas that are high enough to create fusion among susceptible atoms. Therefore, the present invention should be of interest to people interested in cavitating bubbles.

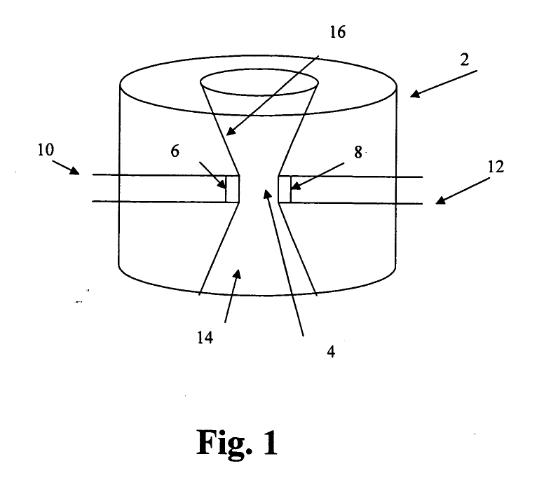

Referring now to FIG. 1, a diagram of a preferred embodiment of a pressure generating piece of test equipment in accordance with the present invention is shown. To the best of the present inventor's knowledge, the relatively simple device of FIG. 1 is unknown in the prior art. The “geek toy” consists of a reaction chamber 2 that has two opposing resistors 6 and 8 positioned on opposing sides of a collapse area 4. The reaction chamber 2 is preferably a small device with the resistors 6 and 8 having dimensions of several micrometers that creates a bubble of the same order of magnitude. The small size of the bubble created facilitates the superheating of the liquid and the corresponding rapid implosion of the bubble. Furthermore, a smaller device provides more precise control over the central region of the bubble collapse which is important for creating the highest possible pressures. The optimum size and characteristics of the firing resistors 6 and 8 depend upon the desired application. It will be noted that embodiments of the present invention can be constructed of almost any size. The key is simply to focus the implosion of the bubble and there is theoretically no limit to the size of the bubble that could be imploded with an embodiment of the present invention. Thus, while a smaller bubble is preferred for fusion experiments due to the particularly rapid manner in which it collapses, imploding bubbles having any radius could easily be created and the present invention is not limited to use in fusion experiments. However, for high, focused pressures, bubbles having dimensions on the order of micrometers and nanometers are preferred.

The bubbles produced by the embodiment of FIG. 1 preferably have a short duration and completely implode after the initial explosion. For illustrative purposes, assume the resistors 6 and 8 are constructed as those set forth in U.S. Pat. No. 5,734,398, which is hereby incorporated by reference. The point is to have resistors that produce a superheated water vapor bubble similar to what is referred to in the '398 patent as “fluctuation nucleation boiling”. The construction and timing of these types of resistors are also set forth in U.S. Pat. No. 6,126,260 which discusses the “pressure wave bombardments” caused by the collapsing bubbles and is also hereby incorporated by reference. Firing resistors are well known in the prior art.

When a short, high amplitude voltage pulse of electricity is sent to the firing resistors 6 and 8 from a pair of conductors 10 and 12, a portion of the fluid in contact with the resistors 6 and 8 is vaporized at its superheat limit for a brief period of time to create an expanding relatively high pressure zone of vaporized, yet mostly unexpanded, water in the collapse zone 4. The surface of the resistors 6 and 8 should be as smooth as possible as bubble nucleation tends to occur at defects in the surface and it is desirable to create regular shaped symmetric bubbles such that their implosion can be precisely controlled and focused. The duration and amplitude of the electrical pulse are experimental parameters that depend upon the concentration and the nature of the material in the collapse zone 4; the pressure and temperature of the fluid filling the bubble production mechanism 2, the shape of the bubble production mechanism 2, and the desired reaction from the implosion. The construction of this type of resistor is well known and an exemplary pulse for activating such a resistor has a duration of approximately 3 microseconds and a maximum voltage of 18 volts. It should be noted that the present invention is a basically a cavitation lens that focuses the energy of a bubble implosion and while a lens is easy enough to create, creating a “perfect” lens for any particular application will require a great deal more effort to determine the precise parameters that produce the optimum results for the particular application. However, in view of this disclosure, one skilled in the art could construct the device of FIG. 1 without any undue experimentation, although sophisticated semiconductor manufacturing equipment will be required for the smallest and most interesting of embodiments.

In the most preferred embodiment, diamond-like-carbon is used to form the resistors 6 and 8 because it resists cavitation damage, transmits heat very efficiently and can be doped to form a resistor. In such an embodiment, the semi-conductor substrate 4 is a diamond-like-carbon layer that has been doped to provide the resistors 6 and 8. A low conductivity electrical path to the resistors can be formed using chemical or vapor deposition as is known. In an alternative embodiment, the reaction chamber can simply be constructed from machined steel and the resistors from ceramic covered resistive metal.

The reaction chamber is filled with a liquid such as water. If desired, material may dissolved or incorporated in the liquid as described in more detail herein. In a particularly interesting experiment, the liquid would be “heavy water”, i.e., water in which an increased portion of the hydrogen consists of the heavy hydrogen isotopes deuterium and tritium. Deuterium and tritium are preferred because they are known to be more susceptible to fusing than other isotopes and elements. Alternatively, a solution of water having Uranium 235 dissolved in it could be used. The unexpectedly large force of the collapse may cause a portion of the Uranium 235 atoms to collide and break apart thereby releasing atomic energy.

The liquid is also preferably heated to its superheat limit when it receives the energy from the resistor. Forming the bubble from the material the liquid is made out of eliminates some of the mass exchange problems discussed in the Physical Review Letter, Volume 72, Number 9, Feb. 28, 1994. However, the present invention can be utilized with different elements and molecules dissolved in any vaporizable solution. A super limit bubble is achieved by applying a high voltage, short duration pulse to the resistor. This will cause a particularly violent explosion and subsequent implosion of the bubble. Superheating is a concept that involves heating a liquid above its boiling point without allowing it to vaporize. Providing the energy to the bubble in a rapid, concentrated manner is important to achieving this superheated cavitation. When the energy hits the liquid, the liquid in contact with the resistor is rapidly heated before it can vaporize. This superheated liquid violently vaporizes as the bubble forms. As the bubble expands, the molecules that make up the bubble are rapidly accelerated to their maximum bubble extension position. This momentum carries the molecules slightly past the position they would obtain if the bubble was in its steady state.

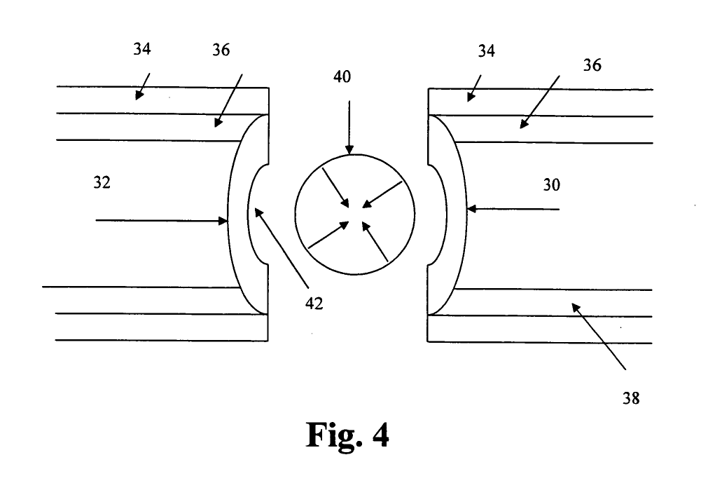

When the energy being supplied to the resistors 6 and 8 power is cut off, the high heat conduction rate of the material used to form the reaction chamber 2 and the cool water surrounding the bubble rapidly cause the water vapor at the edges of the bubble to loose energy and return to the liquid form. For all these reasons and more a phase boundary shock wave and a corresponding high density particle jet are created that rapidly move toward the center of the collapsing bubble. The collapse of the bubble is focused by the edges 16 of the reaction chamber 2 and the heat conductivity of the material from which the resistors 6 and 8 and reaction chamber 2 are constructed toward a center collapse area 4. While they appear flat in FIG. 1, the resistors 6 and 8 of FIG. 1 can be shaped in three dimensions to further control the bubble implosion. An illustrative example is shown in FIG. 4 and discussed in more detail below.

At the point the power supply to the resistor is almost instantaneously cutoff, the energy that was feeding this molecular expansion is now gone. The energy necessary to maintain the vapor form of the bubble is rapidly drained from the bubble due to its small size. Thus, a state change from the liquid phase to the gas phase immediately begins to occur in the molecules at the edges of the bubble. This phase boundary then races toward the center of the bubble as it implodes. This is cavitation. The surface tension energy in this phase boundary also races to the center of the bubble. During its progression to the center, this boundary wave reaches a boundary that marks the liquid volume of the molecules in the bubble. At this point, the bubble disappears and the remaining surface tension energy is imparted to the molecules. The molecules in the imploding bubble almost all have momentum directed toward the center of the imploding bubble thereby inertially containing the molecules at the center of the implosion in a high pressure region. An additional effect is created due to the density of the water molecules in the exploding bubble varying from a minimum at the center of the bubble to a maximum at an outer edge of the bubble. As a result of this asymmetric distribution, a relatively large number of molecules in the outer edge collapse upon a relatively small number of molecules in the center. At this point immense pressures are created in the center of the bubble implosion. The more rapid the state change the greater the pressures created. Thus, forming the superheated bubble in a cold liquid will create a particularly violent implosion of the bubble. Thus, some embodiments of this invention utilize a cooled liquid. Moreover, a preferred embodiment utilizes water slightly above its freezing point to maximize the heat removal from the bubble's edges and increase the force of the implosion.

The liquid utilized by the preferred embodiment of FIG. 1 is preferably pure water that has been degassed such that there are no stray molecules to interfere with the liquid/vapor boundary shock wave traveling toward the center of the imploding bubble. This minimizes the interference that different types of atoms and molecules might cause in the shock wave caused by the phase change of the water molecules. Furthermore, in a most preferred embodiment, where the bubble is a heavy water vapor bubble in liquid heavy water as opposed to a gas bubble such as argon in water, the material in the water bubble does not have to be absorbed by the collapsing water and the shock wave is allowed to rapidly perpetuate to its destruction point. This absorption can undesirably slow the progress of the boundary shock wave and decrease the pressures obtained. Thus, by utilizing a water vapor bubble in water vapor an extremely powerful and well shaped shock wave and corresponding high pressure zone can be created in such a preferred embodiment. Although water is preferred, the compression effect could be achieved with any vaporizable fluid. Furthermore, materials can be dissolved in the water to form solutions that are imploded thereby subjecting a small portion of the dissolved material to very high pressures.

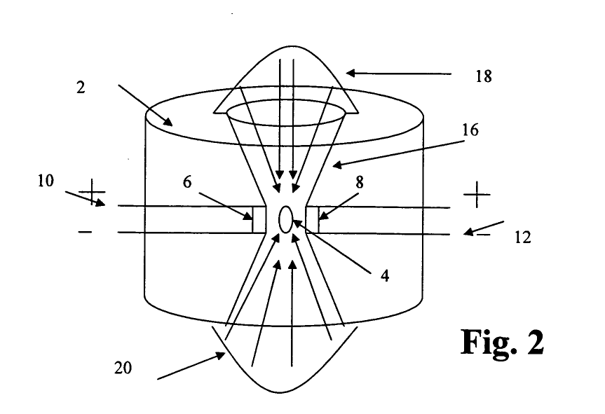

As discussed above, the fusion reaction is initiated by applying a pulse of energy to the two resistors. This pulse of energy causes a portion of the water in the chamber to be vaporized into a bubble that extends out both sides of the chamber as illustrated in FIG. 2. The electrical pulse preferably has a high magnitude and a short duration. For exemplary purposes, assume the pulse has a peak voltage of 18 volts and a pulse duration of approximately 3 microseconds.

The application of such an electrical pulse causes the bubble to reach its maximum expansion in about 7 to 8 microseconds. An exemplary maximum bubble expansion is shown in FIG. 2. FIG. 2 shows the heavy water vapor bubble at its maximum extent 16. As the bubble expands from the collapse zone 4 to its maximum extent 16, the pressure in the chamber begins to increase and resist the bubbles expansion. Furthermore, the rapid expansion is resisted by the water surrounding the expanding bubble. The density of the water particles in the expanding bubble is asymmetrically distributed such that it is lowest near the surface of the resistor and increases toward the bubbles outer surface. Thus, when the bubble collapses, a relatively large number of particles in the outer portion of the bubble collapse upon a relatively small number of particles in the center of the bubble. However, when utilizing a heavy material dissolved in the liquid a small portion of the heavier material will be left behind by the water phase change boundary wave. Some of this heavier material will then be forced together when the bubble collapses.

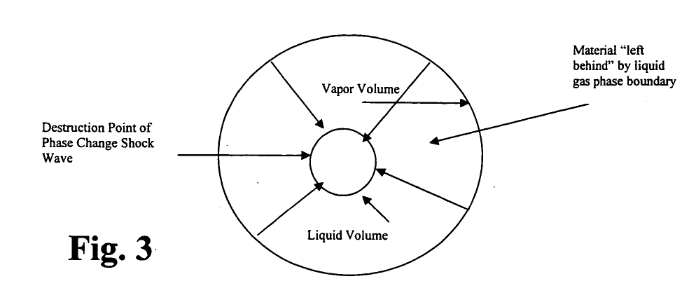

The energy coming from the firing resistor is preferably abruptly cut off and the firing resistor is made of, or coated with, a material that rapidly absorbs or transmits heat to and from the liquid. The high heat conductivity of the resistor and quick termination of the firing pulse encourages the water vapor in the bubble next to the resistor to quickly change to the liquid state and, thus, directs the bubbles collapse away from the firing resistors' surface. Once the electrical pulse is over, the vapor in the bubble will rapidly loose energy and begin to return to its liquid state causing the bubble to collapse or implode towards its liquid volume as illustrated in FIG. 3. This bubble collapse may occur in the span of a few microseconds. As the bubble implodes, a shock wave of matter is created that is directed toward the center of the reaction chamber from both ends of the reaction chamber. These directed shock waves concentrate the pressure into jets of material that, if properly focused, collide with each other in the center of the reaction chamber creating a small zone of immense pressure. The actual pressure distribution in this zone is chaotic and the particles in the zone all have different kinetic energies. Any attempt to measure the highest pressure in this zone will by definition represent some type of average of the kinetic energy of the particles in the area chosen. However, some of the particles in this zone may obtain the kinetic energy necessary to initiate a nuclear reaction. Thus, it is in this zone that the pressures may be high enough to overcome the nuclear forces in the atoms of the material dissolved or incorporated into the water.

A preferred embodiment of the present invention can produce a variety of effects depending upon the thermal pulses provided to the reaction chamber. In a first mode, the firing pulse is insufficient to produce a bubble and no reaction at all is observed to the application of the firing pulse. In a second mode, the firing pulse provides just enough energy to create a small unstable, cavitating bubble that begins to implode as soon as the firing pulse is over. By repeatedly firing the chamber in this manner, a continuously cavitating bubble can be produced that explodes and implodes very rapidly in the confines of the chamber. In such an embodiment, small, rapid implosions/explosions from unstable bubbles will occur that can be focused toward a central high pressure region. In a third mode, the firing pulse delivers so much energy to the liquid that a long lasting vaporization of the liquid occurs. Such a firing pulse will create a chaotic explosion that is not immediately followed by a uniform, cavitation type, implosion. The bubble created is so large that its does not rapidly implode and instead simply explodes. In one final mode, the strength of the firing pulse is so large that the device simply explodes. To prevent this mode from occurring, the device should be built as robust as possible. It is the cavitating state that is most interesting. The duration and amplitude of the firing pulse can be controlled to insure that the device is operating in the cavitation based mode.

The force of the bubble implosion is created by a number of effects. As the water changes from the liquid phase to the gaseous phase, a phase boundary shock wave is created that travels toward the center of a spherical bubble. For example, referring to FIG. 3, consider a water vapor bubble having a diameter of 1 micrometer. Such a water vapor bubble has a certain number of water molecules in the vapor state, n, and a vapor volume, v₁. When the vapor bubble collapses, its number of molecules will remain constant while its volume will change from its vapor volume v₁, to its liquid volume v₂. The vapor volume is considerably larger than the liquid volume. Thus, when the state change occurs in a bubble having a spherical form, the molecules rush toward the center of the bubble's previous volume to form a liquid droplet having the liquid volume. Energy is released in the state change from a vapor to a liquid. This energy partially propels the molecules in the imploding bubble from their vapor location to their liquid location. Energy is also provided by the pressure of the water surrounding the vapor bubble collapsing on the imploding bubble.

In addition to the above described effects, a surface tension wave is created in the phase bubble as the surface tension field having an area equal to the surface of the vapor volume sphere is reduced to a surface tension field that disappears as the molecules in the bubbles reach their vapor volume position. This surface tension energy is also imparted to the molecules in the bubble. Moreover, the energy is departed to the molecules in an uneven fashion as the bubble implodes. This is partly due to the fact that the area of the surface tension field is decreasing as the square of the rate of the speed of the phase shock wave as its approaches it destruction point. The destruction point occurs approximately when the volume of the bubble reaches its liquid volume. This is shown in FIG. 3. At this point there is no surface tension field remaining and the energy in the phase shock wave consisting of the liquid/gas phase boundary and the accompanying surface tension field is imparted to the molecules in the liquid bubble volume in a burst.

When the bubble collapses, some molecules will receive more kinetic energy than other molecules. As previously discussed, one way to increase the number of molecules that will receive enough kinetic energy to initiate a nuclear reaction in the imploding bubble is to shape the implosion in the same way explosions are shaped to increase the maximum pressure in the shaped charges used to initiate nuclear explosions and pierce armor. In a most preferred embodiment of the present invention, a sloped edge is utilized to focus the force of the imploding bubble into a small area as shown in FIG. 1. Alternatively, the firing resistors may be shaped like the hollowed out bottom forth of a sphere as shown in FIG. 4 and discussed in more detail below. In preferred embodiments of the present invention, opposing shock waves are created that crash together in a minimized area. The idea is to focus the force of the implosion on a single point and inertially contain a small amount of material at a high pressure. However, if the shock wave is directed toward the energy providing object that initiates the bubble, the energy providing object may be destroyed by the shockwave. Thus, the phase shock waves are preferably focused at an area away from the firing resistors.

As a further example of the present invention, consider the embodiment of FIG. 4. In this embodiment, the resistors 30 and 32 have a hollowed-out quarter sphere shape 42 that is designed to produce a spherical high pressure zone 40 in the center of the device. The contoured shape of the resistor influences the shape of the bubble implosion. The electrical conductors 36 and 38 provide a pulse of electricity to opposite ends of the resistors 30 and 32. An isolation layer 34 protects the conductors from the liquid in the compression zone 40. By constructing the surface of the firing resistors 30 and 32 out of a material that has a high heat conductivity, the edges of the imploding bubble can be made to pull away from the edges of the firing resistors 30 and 32. Thus, the high pressure zone 40 occurs away from the edge of the device in a region that is exposed to the liquid surrounding the reactor. This minimizes damage to the resistors 30 and 32 and assists in producing a rapidly collapsing bubble. In other embodiments of the present invention, a plurality of resistors in a plurality of locations may be used to shape the bubble in almost any form desired.

An approximation of the theoretical maximum energy imparted to two molecules by the present invention is the power of the firing pulse. Thus, if the bubble imploder could be perfectly controlled to focus the energy of a firing pulse onto two molecules, each molecule would have an amount of kinetic energy equal to approximately half the energy of the firing pulse. Thus, it can be seen that if the cavitation can be precisely controlled, a great deal of kinetic energy can be provided to molecules in an imploding bubble. Thus, in certain circumstances, some molecules may receive an amount of kinetic energy sufficient to initiate a nuclear reaction in the collapsing bubble.

Fusion reactions are known to occur in cavitating bubbles. The brief flashes of light illustrated in the sonoluminescence of fluids subjected to shock waves are examples of this effect. However, the pressure created by the bubbles created in these experiments is not strong enough to create a fusion or fission reaction in the vast majority of particles in the fluid. Thus, only miniscule releases of energy occur which are witnessed as flashes of light. In order to create a useful device, the shock wave of the collapsing bubble and the assortment of elements in the fluid must be properly manipulated as described herein.

One way to increase the number of molecules in the bubble that acquire the kinetic energy and inertial confinement required to overcome their nuclear forces is to use molecules in the bubble that are unstable to begin with. As previously discussed, deuterium or tritium molecules may be used as the hydrogen in the water molecules that form the imploding bubble. When the bubble implodes, if it is properly focused, a portion of the molecules may acquire the kinetic energy necessary to initiate a nuclear reaction. This is particularly true at the destruction point of the phase boundary wave where a large amount of energy is focused in a small area. Also, the higher the concentration of the deuterium and tritium, the more likely such an event is to occur.

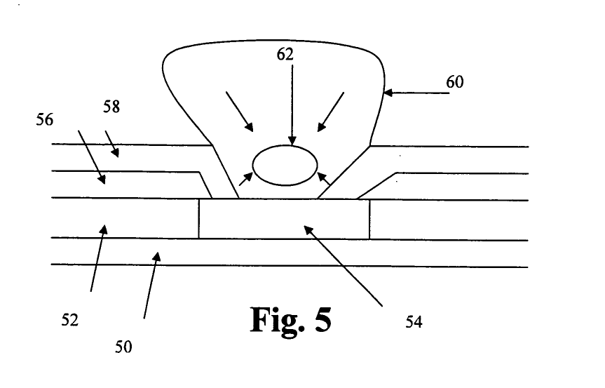

Referring now to FIG. 5 a single heating element 54 embodiment of the present invention is shown. The heating element 54 is constructed on a semiconductor substrate by using sputtering, chemical or vapor deposition, etching or other means to form a resistor 54 in a layer of material 52. Conductive paths 56 are then formed to provide electricity to the resistor 54. Finally, a shaping layer 58 is formed to shape the implosion of the bubble. The shaping layer 58 achieves this result in two different ways. First, the heat conductivity of the material of the layer 58 influences the rate at which heat is removed from the portion of the bubble in contact with the shaping layer 58 once the pulse of electricity is over. Secondly, the sloped edge of the shaping layer 58 in the region of the high pressure zone 62 focuses the implosion of the bubble toward the high pressure zone.

Consider the embodiment of FIG. 5 when a bubble is produced. The bubble will rapidly expand toward its maximum extent 60. Then, when the power is removed, the bubble will begin imploding from its maximum extent 60 where the water vapor is in contact with liquid water toward its liquid volume in the high pressure zone 62. The high heat conductivity of the shaping layer 58 will cause the bubble to collapse away from the shaping layer 58, however, the outer bubble boundary will collapse much quicker than the bubble boundary created by the shaping layer 58 and the resistive surface 54. Thus, a shaped shockwave from the outer bubble boundary 60 will collide with a shockwave rising off of the shaping layer 58 and resistor 54 surface in the high pressure zone 62. It is in this region that the extremely high pressures of the present invention are created.

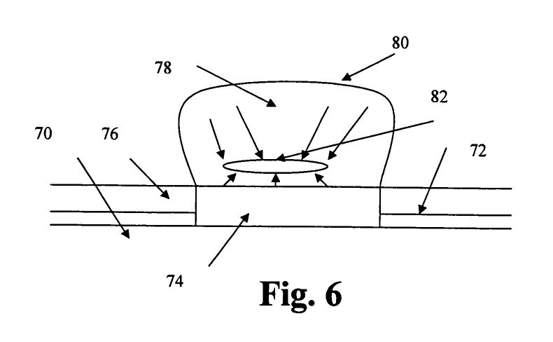

In FIG. 6 an alternative embodiment of the present invention based upon a standard firing resistor 74 is shown. The resistor 74 is constructed on a semi-conductor substrate 70 and supplied by conductive traces 72 covered by a protective layer 76. When a bubble 78 is created it expands to its maximum extent 80 and collapses into a high pressure region 82. The flat nature of the resistor 74 results in an elliptical high pressure zone 82 that is less focused than that of FIG. 1.

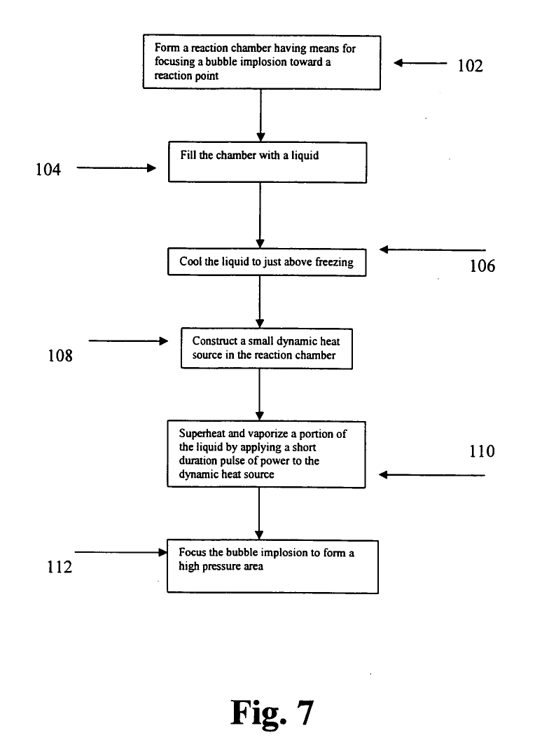

A preferred method of creating a focused bubble implosion is set forth in FIG. 7. In block 102, the method commences with the forming of a cavitation chamber having means for focusing the bubble implosion toward a reaction point. The cavitation chamber is then filled with a liquid in block 104. The liquid is cooled in block 106. A small dynamic heat source is constructed in the reaction chamber as shown in block 108. The method then proceeds to block 110 where a portion of the water is vaporized by a applying a short duration pulse of power to the dynamic heat source. The method is completed by focusing the imploding bubble to form a high pressure area as shown in block 112.

The above discussed embodiments of the invention are exemplary only and not intended to limit the scope of the present invention. Many different materials could be used in a variety of different reactors constructed in accordance with the present invention. Furthermore, the present invention could be used in an infinite number of applications as the utility of creating high pressure regions is self evident. Therefore, the proper scope of the present invention is set forth in the claims below.

I claim:

1. An apparatus for producing a high pressure zone, said apparatus comprising:
a microprocessor for controlling said apparatus;
a pulse generator for selectively producing a voltage pulse having a predetermined magnitude and duration at the request of said microprocessor;
a heating element for receiving said voltage pulse and producing a superheated bubble in a liquid; and
a reaction chamber for focusing the implosion of the superheated bubble into a high pressure zone.

2. The apparatus of claim 1 wherein the liquid is water and a material is dissolved in the water.

3. The apparatus of claim 1 wherein the liquid is pressurized.

4. The apparatus of claim 1 wherein the liquid is cooled.

5. The apparatus of claim 1 wherein the surface of the resistive heating element is contoured to shape the bubble implosion.

6. The apparatus of claim 1 wherein the thermal conductivity of the material from which the heating element is constructed is selected to shape the bubble implosion.

7. A device for focusing the implosion of a bubble into a high pressure region, said device comprising:
a resistive heating element for producing a phase bubble in a liquid;
a microprocessor for producing a firing pulse and circuitry for providing said firing pulse to said resistive heating element; and
a reaction chamber containing said resistive element for focusing the implosion of the phase bubble into a high pressure zone.

8. The apparatus of claim 7 wherein the liquid is water and a portion of the hydrogen in said water has been replaced with tritium and deuterium.

9. The apparatus of claim 7 wherein the reaction chamber is constructed using a semiconductor deposition process.

10. The apparatus of claim 7 wherein the resistive heating element has a passivation layer of diamond-like carbon.

11. The apparatus of claim 7 wherein the resistive heating element is contoured to shape the bubble implosion created by the resistive heating element in response to the firing pulse.

12. The apparatus of claim 7 wherein the materials from which the resistive heating element is constructed are selected to have a high thermal conductivity.

13. A bubble imploding device for shaping an expansion and contraction of a phase bubble toward a reaction zone, said device comprising a reaction chamber having a resistive element for producing a phase bubble in a liquid wherein said reaction chamber has sidewalls for shaping an expansion of said phase bubble during a heating phase of said bubble implosion and shaping an implosion of the phase bubble in an implosion phase of said bubble implosion such that said bubble implodes upon a central reaction area of said reaction chamber to produce a high pressure point.

14. The device of claim 13 wherein said reaction chamber comprises a pair of hollow opposed cones wherein the points of the hollow cones are joined and wherein said resistive element is positioned adjacent the junction of said hollow cones such that sidewalls of said hollow opposed cones shape the expansion and implosion of said phase bubble.

15. The device of claim 13 further comprising a microprocessor controlled pulse generator wherein said phase bubble is produced by said pulse generator providing a firing pulse of approximately 3 microseconds in duration and approximately 18 volts in amplitude to said resistive element.

16. The device of claim 13 wherein said phase bubble has a maximum diameter of less than 1 micrometer.

17. The device of claim 13 further comprising radioactive isotopes dissolved in said liquid.

18. The device of claim 13 wherein said reaction chamber is constructed from a material having a high thermal conductivity.

19. The device of claim 13 wherein said resistive element is located such that it is outside of said high pressure point.

20. The device of claim 13 wherein a central area of said bubble implosion is directed away from said resistive element.
